(19) United States
(12) Patent Application Publication
(10) Pub. No.: US 2025/0378254 A1
(43) Pub. Date: Dec. 11, 2025

(54) Method and System for Tracking Integrated Circuit Physical Design Verification

(71) Applicant: International Business Machines Corporation, Armonk, NY (US)

(72) Inventors: Jahnavi Amam, Austin, TX (US); Sean Salisbury, Poughkeepsie, NY (US); David Wolpert, Poughkeepsie, NY (US); Frank Malgioglio, Hopewell Junction, NY (US); Charles Schmitter, Poughkeepsie, NY (US); Amanda Christine Venton, Austin, TX (US); Jennifer Elizabeth Basile, Poughkeepsie, NY (US)

(21) Appl. No.: 18/734,216

(22) Filed: Jun. 5, 2024

(51) Int. Cl. G06F 30/398; G06F 119/12

(52) U.S. Cl. CPC G06F 30/398; G06F 2119/12

(57) ABSTRACT

A computer-implemented method for physical design verification (PDV) of a chip includes detecting new data associated with a chip design. The method includes determining differences between previous data associated with the chip design and the detected new data. The method includes determining, based on the differences, checking runs to be submitted for verification of different aspects of the chip. The method includes predicting one or more suitable execution machines for running the checking runs. The method includes identifying a list of available execution machines from the suitable execution machines for executing the checking runs. The method includes submitting the checking runs for execution and monitoring the status of submitted checking runs. The method includes generating a file containing the status of the checking runs.

### BACKGROUND

The present disclosure relates generally to integrated circuit design, and more specifically to a method and system for automatically tracking integrated circuit physical design verification.

Physical Design Verification (PDV) is a crucial step in the semiconductor integrated circuit (IC) design (e.g., chip design) process that occurs before IC fabrication. PDV involves running numerous checks on the IC to ensure compliance with various rules and specifications relating to layout, shape, timing, power consumption, signal integrity, and manufacturing constraints.

PDV ensures that a chip design complies with all predefined rules and guidelines. These rules are established to ensure the proper functioning and performance of the chip once fabricated. By verifying compliance early in the design process, potential issues can be identified and addressed before they become costly problems during fabrication or in the final product. PDV helps minimize the risk of such issues by identifying and rectifying design violations beforehand.

Chip design is often an iterative process, with a team of engineers continuously modifying, refining and optimizing the design. When a chip design is modified, a new iteration of the chip design is created. Each iteration introduces the potential for new design violations or issues. By subjecting every iteration to PDV, designers can maintain design integrity and ensure that each version of the chip meets the necessary criteria for fabrication and performance.

In practice, PDV involves running hundreds of checking runs (also referred to as PDV jobs) on the chip design to verify its compliance with various rules and constraints. Traditional approaches to keeping track of the status of checking runs (PDV jobs) have several drawbacks. Generally, a large number of checking runs are submitted simultaneously. Thus, it is challenging to monitor which runs are completed, ongoing, aborted or fully reviewed. Also, recalling the checking runs submitted for previous iterations of the chip design is cumbersome.

Design team members often rely on email notifications or physically checking the run location to monitor the status of runs. This method is inefficient and time-consuming, leading to delays in accessing critical information about the status of the PDV process.

Sometimes, a team member is tasked with compiling daily updates on run statuses and reporting them. However, this process is highly time-intensive, as it requires manually gathering and organizing data from various sources. Also, a team faces challenges in making timely submissions of checking runs when new data is available. The team is dependent on having a team member available to submit the jobs promptly.

These challenges highlight the need for a more efficient and streamlined approach to managing the PDV process, including improved tracking mechanisms, communication tools, and automation to reduce manual effort and improve productivity.

### SUMMARY

Illustrative embodiments provide a computer-implemented method for physical design verification (PDV) of a chip. The method includes detecting new data associated with a chip design and determining differences between previous data associated with the chip design and the detected new data. The method includes determining, based on the differences, checking runs (PDV jobs) to be submitted for verification of different aspects of the chip. The method includes predicting one or more suitable execution machines for running the checking runs and identifying a list of available execution machines from the suitable execution machines for executing the checking runs. The method includes submitting the checking runs for execution on at least one of the available execution machines. The method includes monitoring the status of the submitted checking runs and generating a file containing the status of the checking runs. The checking runs include tests designed to verify physical layout, functionality, timing, and power consumption of the chip. According to other illustrative embodiments, a system and a computer program product for physical design verification (PDV) of a chip are provided.

### BRIEF DESCRIPTION OF THE DRAWINGS

FIG. 1 is a representation of a network of data processing system in which illustrative embodiments may be implemented;

FIG. 2 is a functional block diagram of a system for tracking and managing a physical design verification (PDV) in accordance with an illustrative embodiment;

FIG. 3 is a flowchart of a process for a computer-implemented method for a PDV;

FIG. 4 is a flowchart of various interactions between users and a PDV application;

FIGS. 5A-5B depict a screen displaying a table created by a PDV application; and

FIG. 6 illustrates a block diagram of a data processing system in accordance with an illustrative embodiment.

### DETAILED DESCRIPTION

The illustrative embodiments address limitations of existing physical design verification (PDV) processes. The illustrative embodiments provide an efficient and streamlined approach to managing the PDV process, including improved tracking mechanisms, communication tools, and automation to reduce manual effort and improve productivity.

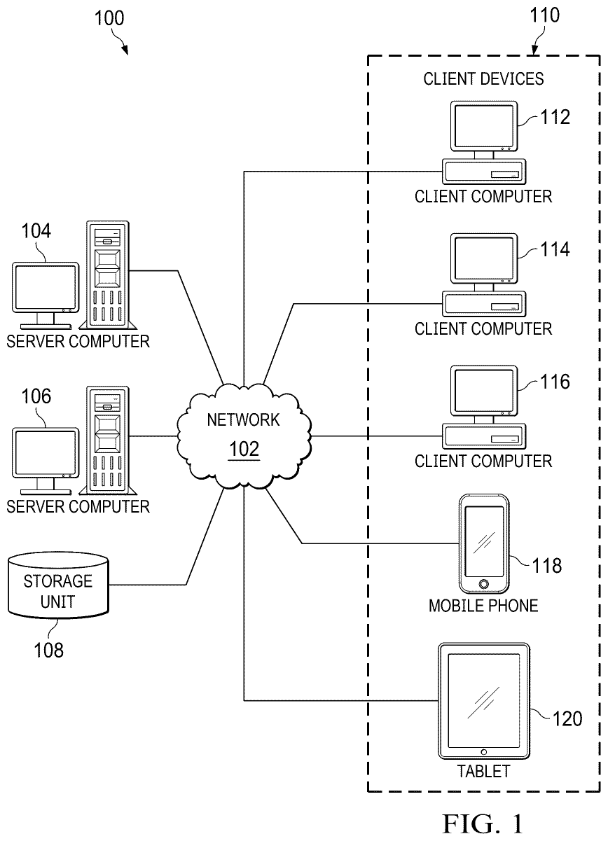

With reference to FIG. 1, a representation of a network of data processing system is depicted in which illustrative embodiments may be implemented. Network data processing system 100 is a network of computers in which the illustrative embodiments may be implemented. Network data processing system 100 contains network 102, which is the medium used to provide communications links between various devices and computers connected within network data processing system 100. Network 102 may include connections, such as wire, wireless communication links, satellite communication links or fiber optic cables.

In the depicted example, server computers 104 and 106 and storage unit 108 connect to network 102. In addition, client devices 110 connect to network 102. Server computers 104 and 106 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118 and tablet computer 120. Although system 100 includes only servers 104 and 106, system 100 can include any number of servers.

In the illustrative example of FIG. 1, server computers 104 and 106, storage unit 108, and client devices 110 are network devices that connect to network 102 in which network 102 is the communications media for these network devices.

Program code located in network data processing system 100 can be stored on a computer-recordable storage medium and downloaded to a data processing system or other device for use. For example, the program code can be stored on a computer-recordable storage medium on server computers 104 and 106 and storage unit 108 and downloaded to client devices 110 over network 102 for use on client devices 110. The program code can also be stored on a computer-recordable storage medium on client devices 110. Clients may also send requests through network 102 to launch jobs on server computers 104 and 106.

In the illustrative example of FIG. 1, network 102 can be the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Network data processing system 100 also may be implemented using different types of networks. For example, network 102 can be comprised an intranet, a local area network (LAN), a metropolitan area network (MAN), or a wide area network (WAN). FIG. 1 is intended as an example, and not as an architectural limitation for the different illustrative embodiments.

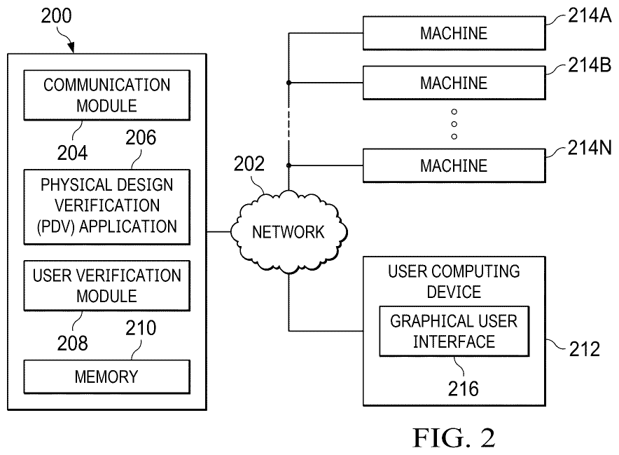

FIG. 2 is a functional block diagram of physical design verification (PDV) System 200 for tracking and managing PDV in accordance with an illustrative embodiment. PDV System 200 provides an efficient and automated process for managing PDV, including improved tracking mechanisms, communication tools, and automation to reduce manual effort and improve productivity.

In an illustrative embodiment, PDV System 200 is connected to user computing device 212 and a plurality of machines 214A-214N via communication network 202. Although in this example, PDV System 200 is connected to only one user computing device, PDV System 200 may be connected to any number of user computing devices.

Network 202 can be, for example, a LAN, a WAN such as the Internet, or a combination of the two, and can include wired, wireless, or fiber optic connections. In general, network 202 can be any combination or connections and protocols that will support communications between user computing device 212, machines 214A-214N and system 200.

PDV System 200 includes communication module 204 which establishes communication among user computing device 212, machines 214A-214N and various components of PDV System 200. Communication module 204 enables user computing device 212 to access other components of PDV System 200.

PDV System 200 includes PDV application 206 which serves as the control system for managing and tracking a PDV process of a chip design. During a PDV process, a team of engineers may create scripts that contain a series of checking runs (also referred to as PDV jobs) or tests to verify different aspects of the chip design, such as physical layout, functionality, timing and power consumption. Depending on the script, specific checks are either enabled or disabled. These checking runs (PDV jobs) are submitted by users to PDV application 206 for execution. PDV application 206 coordinates the submission, execution, and tracking of checking runs, ensuring efficient resource utilization and timely feedback to engineers.

In an illustrative embodiment, PDV application 206 is a software application running on a server or cluster. PDV application 206 may include program code or program instructions configured to submit, execute, track and manage checking runs (PDV jobs).

PDV application 206 is responsible for selecting a suitable machine from a pool of available machines on which to run the checking runs. This selection is based on various criteria such as CPU availability, performance, run time of checking runs, current workload on each machine, and any specific requirements of the checking runs (e.g., memory or hardware dependencies). Since many checking runs may be submitted simultaneously by multiple engineers, PDV application 206 efficiently allocates resources and schedules the execution of these runs to minimize waiting times and maximize throughput.

In the illustrative embodiment of FIG. 2, PDV application 206 selects one or more execution machines from machines 214A-214N to run the checking runs. Machines 214A-214N are responsible for running the checking runs. They provide the computational resources (e.g., CPU, memory, and specialized hardware) needed to execute the tests. Execution machines may vary in terms of hardware specifications and performance characteristics. In an illustrative embodiment, machines 214A-214N are high-performance servers or compute clusters optimized for running verification workloads.

PDV System 200 includes user authentication module 208 configured to authenticate a user seeking access PDV application 206. Authentication module 208 determines that the user is authorized to access PDV application 206 and what type of access the user is permitted.

PDV System 200 includes memory 210 configured to store data generated by PDV application 206. Memory 210 may also store data accessed by a user via user computing device 212. Memory 210 may also store any changes, notes, scripts or any other user generated information and corresponding data. Memory 210 can be, for example, a hard disk drive, a solid state drive, a RAM, a ROM, or a flash memory.

User computing device 212 represents a computing device which includes graphical user interface 216. Graphical user interface 216 can be any application configured to allow a user to access PDV application 206, submit checking runs or scripts, and track and manage checking runs or scripts. Graphical user interface 216 allows a user to upload, change, delete, alter or update data accessible to PDV application 206.

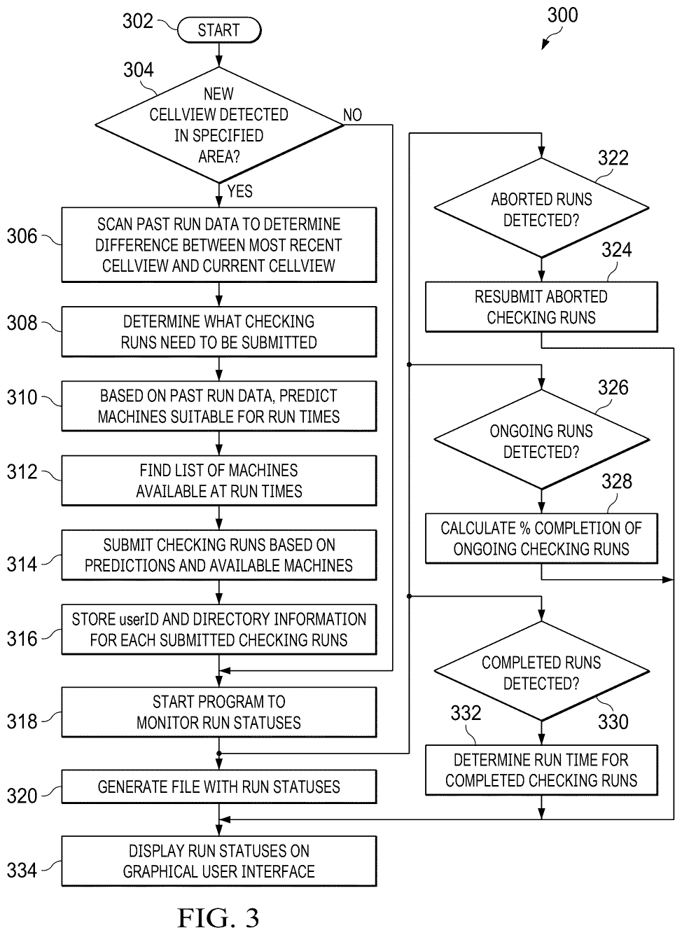

With reference next to FIG. 3, a flowchart of process 300 for a computer-implemented method for PDV is provided. Process begins at 302. Next, at decision block 304, PDV application 206 determines if a new cellview is detected in, for example, a user-specified area of an electronic design automation (EDA) application. EDA applications are used in simulation, design and verification of electronic circuits. The specified area refers to an area where the EDA application stores data associated with a specific chip design. The term “cellview” refers to data associated with a specific version or iteration of chip design. As the chip design is modified, updated, altered or optimized, a “new cellview” is generated in the EDA application by engineers. For example, a chip design may have an (N-1)^{th} cellview created on a particular date and may have an N^{th} cellview created the following day due to updates or modifications to the chip design.

If a new cellview is detected, at block 306 PDV application 206 determines differences between the previous cellview (e.g., N-1) and the current cellview (e.g., N). For example, PDV application 206 can scan past run data to identify differences between the previous data (N-1) and the new data (N).

At block 308, based on the differences between the previous data and the new data, PDV application 206 determines what checking runs need to be submitted. There may be specific checking runs or tests designed to verify different aspects of the chip design. For example, there may be specific checking runs designed to verify physical layout, functionality, timing, or power consumption of a chip. PDV application 206 can enable or disable specific checking runs. PDV application 206 submits or enables the selected checking runs for execution.

At block 310, PDV application 206 predicts one or more suitable execution machines on which to run the checking runs. PDV application 206 may predict one or more execution machines based on various criteria such as CPU availability, performance, run time of checking runs, current workload on each machine, and any specific requirements of the checking runs (e.g., memory or hardware dependencies).

At block 312, PDV application 206 finds a list of available execution machines from the suitable execution machines on which to run the checking runs. Since many checking runs may be submitted simultaneously by multiple engineers, PDV application 206 efficiently allocates resources and schedules the execution of these runs to minimize waiting times and maximize throughput.

At block 314, PDV application 206 submits the checking runs based on the predictions and the available machines. At block 316, PDV application 206 stores user-ID and directory information associated with submitted checking runs. For example, PDV application 206 may store user-ID and directory information associated with submitted checking runs in memory 210.

At block 318, PDV application 206 starts a program to monitor statuses of submitted checking runs. At block 320, PDV application 206 generates a file which contains the statuses of the checking runs. For example, PDV application may create a table which contains the statuses of the checking runs.

At block 322, PDV application 206 detects if there are any aborted checking runs. If there are any aborted checking runs, at block 324, PDV application 206 resubmits the checking runs.

At block 326, PDV application 206 detects if there are any ongoing checking runs. If there are any ongoing checking runs, at block 328, PDV application 206 calculates % completion of the ongoing checking runs.

At block 330, PDV application 206 detects if there are any completed checking runs. If there are any completed checking runs, at block 332, PDV application 206 determines the run time for the completed checking runs.

At block 334, PDV application 206 displays runs statutes on a graphical user interface. For example, PDV application 206 may display file (block 320), aborted checking runs (block 324), % completion of ongoing checking runs (block 328) and run time of completed checking runs (block 332). The graphical user interface can be any application configured to allow a user to access and interact with PDV application 206.

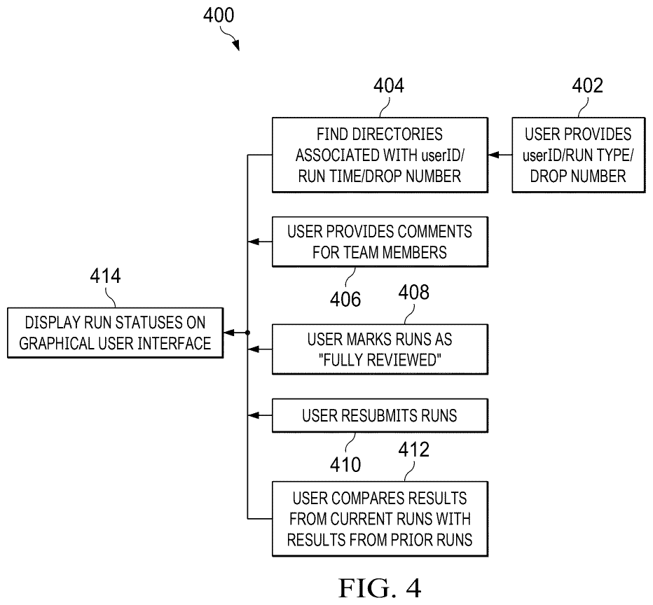

With reference next to FIG. 4, a flowchart of process 400 for various interactions between a user and PDV application 206 is provided. At block 402, a user provides user/ID/run type/drop number to PDV application 206 via a graphical user interface. In this context, a drop number refers to a version or an iteration of a cellview associated with a chip design. In response, at block 404, PDV application 206 finds directories associated with the user-ID/run type/drop number, and at block 414, the information is presented via a graphical user interface. At block 406, the user may leave comments for other team members to read, and those comments are provided via the graphical user interface at block 414. At block 408, the user may mark one or more runs as “fully viewed” and such notes are provided via the graphical user interface. At block 410, the user may resubmit any runs via the graphical user interface. Finally, at block 412, the user may compare results from current runs with results from prior runs stored in memory 210.

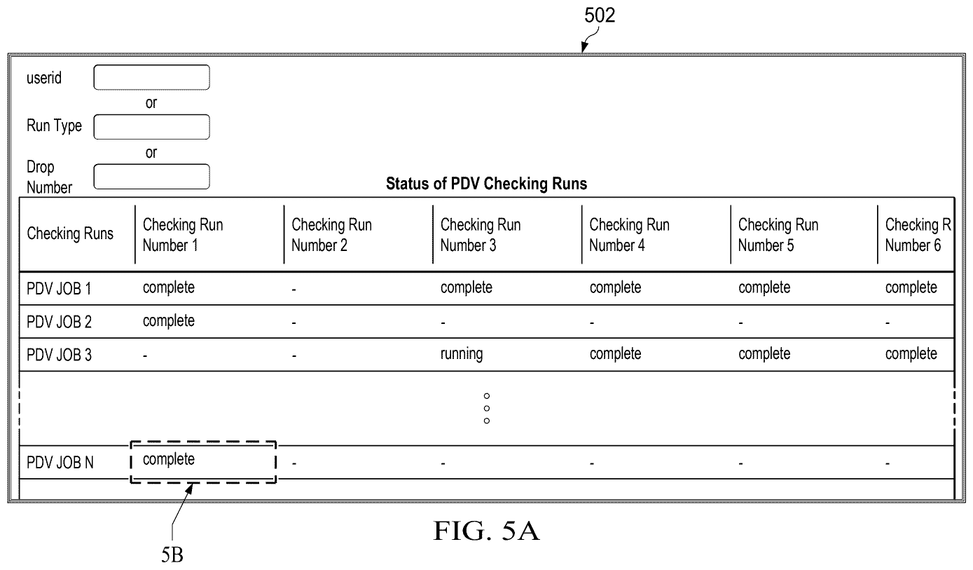

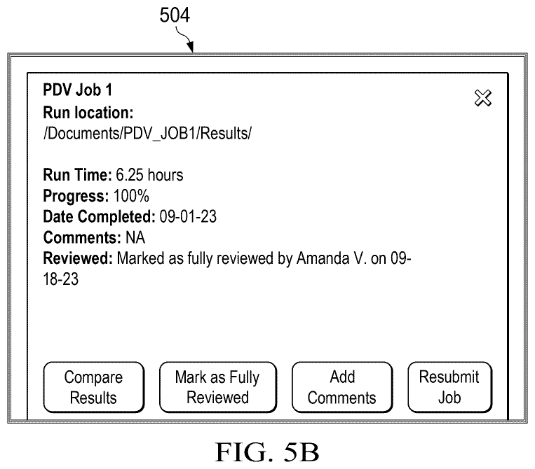

FIGS. 5A-5B depict a screen displaying an exemplary table 502 created by PDV application 206. Table 502 (shown in FIG. 5A) outlines the status of various checking runs, distinguishing between those that are finished, currently in progress, and aborted. Users can interact with the table by clicking on the status of a checking run. For example, by clicking on a completed checking run, window 504 (shown in FIG. 5B) is opened which reveals further details about the completed checking run. Window 504 provides information such as directory, runtime, completion date, and other relevant data. In other embodiments, PDV application 206 can present the status of various runs in other formats.

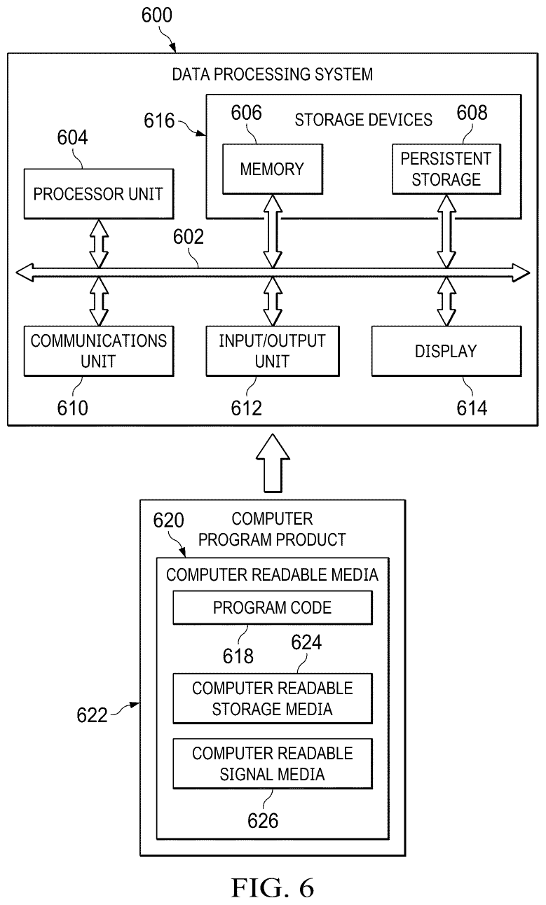

Turning now to FIG. 6, an illustration of a block diagram of a data processing system is depicted in accordance with an illustrative embodiment. Data processing system 600 may be used to implement server computers 104 and 106 and client devices 110 in FIG. 1, as well as system 200 in FIG. 2. In this illustrative example, data processing system 600 includes communications framework 602, which provides communications between processor unit 604, memory 606, persistent storage 608, communications unit 610, input/output unit 612, and display 614. In this example, communications framework 602 may take the form of a bus system.

Processor unit 604 serves to execute instructions for software that may be loaded into memory 506. Processor unit 604 may be a number of processors, a multi-processor core, or some other type of processor, depending on the particular implementation. In an embodiment, processor unit 604 comprises one or more conventional general-purpose central processing units (CPUs). In an alternate embodiment, processor unit 604 comprises one or more graphical processing units (GPUs).

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer-readable storage devices in these illustrative examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608. Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606. These instructions are referred to as program code, computer-usable program code, or computer-readable program code that may be read and executed by a processor in processor unit 604. The program code in the different embodiments may be embodied on different physical or computer-readable storage media, such as memory 606 or persistent storage 608.

Program code 618 is located in a functional form on computer-readable media 620 that is selectively removable and may be loaded onto or transferred to data processing system 600 for execution by processor unit 604. Program code 618 and computer-readable media 620 form computer program product 622 in these illustrative examples. In one example, computer-readable media 620 may be computer-readable storage media 624 or computer-readable signal media 626.

In these illustrative examples, computer-readable storage media 624 is a physical or tangible storage device used to store program code 618 rather than a medium that propagates or transmits program code 618. Computer readable storage media 624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 618 may be transferred to data processing system 600 using computer-readable signal media 626. Computer-readable signal media 626 may be, for example, a propagated data signal containing program code 618.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for physical design verification (PDV) of a chip, comprising:
detecting new data associated with a chip design;
determining differences between previous data associated with the chip design and the detected new data;
determining, based on the differences, checking runs to be submitted for verification of different aspects of the chip design;
predicting one or more suitable execution machines for running the checking runs;
identifying a list of available execution machines from the suitable execution machines for executing the checking runs;
submitting the checking runs for execution on at least one of the available execution machines; and
monitoring the status of the submitted checking runs and generating a file containing the status of the checking runs.

2. The method of claim 1, wherein the checking runs include tests designed to verify physical layout, functionality, timing, and power consumption of the chip.

3. The method of claim 1, wherein the new data is generated in an EDA application in response to modifications, updates, alterations, or optimizations made to the chip design.

4. The method of claim 1, wherein the predicted one or more suitable execution machines are determined based on availability of memory and hardware dependencies required for the checking runs.

5. The method of claim 1, wherein the status includes aborted checking runs, ongoing checking runs and completed checking runs.

6. The method of claim 1, further comprising storing user-ID and directory information associated with the submitted checking runs in a memory.

7. The method of claim 1, further comprising:
detecting ongoing checking runs; and
calculating percent completion of the ongoing checking runs.

8. The method of claim 1, further comprising:
detecting completed checking runs; and
determining run time of the completed checking runs.

9. The method of claim 1, further comprising:
detecting aborted checking runs; and
resubmitting the aborted checking runs.

10. A system for physical design verification (PDV) of a chip, comprising:
a storage device configured to store program instructions; and
one or more processors operably connected to the storage device and configured to execute the program instructions to cause the system to:
detect new data associated with a chip design;
determine differences between previous data associated with the chip design and the detected new data;
determine, based on the differences, checking runs to be submitted for verification of different aspects of the chip;
predict one or more suitable execution machines for running the checking runs;
identify a list of available execution machines from the suitable execution machines for executing the checking runs;
submit the checking runs for execution on at least one of the available execution machines; and
monitor the status of the submitted checking runs and generate a file containing the status of the checking runs.

11. The system of claim 10, wherein the checking runs include tests designed to verify physical layout, functionality, timing, and power consumption of the chip.

12. The system of claim 10, wherein the new data is generated in an EDA application in response to modifications, updates, alterations, or optimizations made to the chip.

13. The system of claim 10, wherein the predicted one or more suitable execution machines are determined based on availability of memory and hardware dependencies required for the checking runs.

14. The system of claim 10, wherein the status includes aborted checking runs, ongoing checking runs and completed checking runs.

15. A computer program product for physical design verification (PDV) of a chip, comprising:
a computer-readable storage medium having program instructions embodied thereon to perform the steps of:
detecting new data associated with a chip design;
determining differences between previous data associated with the chip design and the detected new data;
determining, based on the differences, checking runs to be submitted for verification of different aspects of the chip;
predicting one or more suitable execution machines for running the checking runs;
identifying a list of available execution machines from the suitable execution machines for executing the checking runs;
submitting the checking runs for execution on at least one of the available execution machines; and
monitoring the status of the submitted checking runs and generating a file containing the status of the checking runs.

16. The computer program product of claim 15, wherein the new data is generated by an EDA application in response to modifications, updates, alterations, or optimizations made to the chip.

17. The computer program product of claim 15, wherein the predicted one or more suitable execution machines are determined based on availability of memory and hardware dependencies required for the checking runs.

18. The computer program product of claim 15, further comprising instructions for:
detecting ongoing checking runs; and
calculating percent completion of the ongoing checking runs.

19. The computer program product of claim 15, further comprising instructions for:
detecting completed checking runs; and
determining run time of the completed checking runs.

20. The computer program product of claim 15, further comprising instructions for:
detecting aborted checking runs; and
resubmitting the aborted checking runs.
